(19) United States
(12) Patent Application Publication
(10) Pub. No.: US 2003/0156923 A1
(43) Pub. Date: Aug. 21, 2003

(54) Indexing plunger

(76) Inventors: John M. Winkler, Mukwonago, WI (US); Tony J. Cavadias, Mukwonago, WI (US)

Correspondence Address: JOSEPH S. HEINO, ESQ., DAVIS & KUELTHAU, S.C., 111 E. KILBOURN, SUITE 1400, MILWAUKEE, WI, 53202-6613, US

(21) Appl. No.: 10/077,021

(22) Filed: Feb. 16, 2002

(51) Int. Cl. F16B 21/00

(52) U.S. Cl. 411/552

(57) ABSTRACT

An indexing plunger is provided whereby a first downward force exerted on a hand grip or a lever will move a pin assembly downwardly and whereby a second rotating force exerted on the hand grip or the lever either clockwise or counterclockwise will lock the device into place by extending the locating pin and thereby locking it into place using the compression force exerted by an internal spring. This embodiment can assume a number of different physical configurations. In another preferred embodiment, the object is to provide an indexing plunger that moves the locating pin incrementally downwardly through the housing when the handgrip is rotated in the clockwise direction. At all times during the pin's downward movement, a compression spring maintains an opposing force on the handgrip.

### FIELD OF THE INVENTION

The device of the present invention is generally related to movable locating pins and the like. More particularly, it relates to devices such as indexing plungers that incorporate such locating pins and that are also used for mechanically positioning one item relative to another item whereby movement between the items is prevented and relative position is maintained between those items until it is desired or required that the items be repositioned.

### BACKGROUND OF THE INVENTION

In the experience of these inventors, there are many types and styles of locating devices, or indexing plungers, that are commercially available. Generally speaking, all share some commonality of purpose. For example, most indexing plungers of the type known to these inventors are used for the positioning, locating, holding or securing of one item in relative position to another item. That is, where two items are slidably mateable, for example, it may be desireable to prevent the relative movement between the items. Movement may be prevented by use of an indexing plunger that is mounted on one item and by the use of a mating receiver, such as an aperture, that is mounted on or defined within the second item. One example of this would be a telescoping pole where relative position is maintained between two cylindrical and mating pole members, one pole member having a slightly greater diameter than the other such that the pole members are slidable, one being slidable over and along the other. In this example, a first pole member may have a locating plunger mounted along its outer surface and a second pole member may have a plurality of holes, all aligned generally longitudinally along the second pole, such that engagement of the indexing plunger with any one of the holes will halt movement of the poles and secure the poles in position relative to one another. Disengagement of the indexing plunger allows the poles to slideably move until another position is desired, and so on. Generally, the indexing plunger provides for a retractable pin that can be mounted into any threaded hole. The retractable pin is typically spring biased such that the pin extends outwardly from the plunger in its normal position. In this fashion, the pin engages the mating aperture until the pin is forcibly pulled and retracted away from the aperture. The differences between the various models that are commercially available generally consist of the way in which the pin is extended and the distance it extends, and so on.

In the experience of these inventors, the clearance between parts in a mechanical setting is often such that movement of the retractable pin in an indexing plunger is made difficult due to the close proximity to other parts of a machine. In that setting, there is only so much movement that can be realized by the pin and such amount of movement may be insufficient to securely hold the parts relative to one another. Also in the experience of these inventors, indexing plungers of current manufacture utilize locating pins that are just held in place by the reverse action of a spring. If someone or something inadvertently pulled out on the hand knob, or if someone or something inadvertently pushed the end of the locating pin, the pin could, and often will, disengage from its set position.

### SUMMARY OF THE INVENTION

It is, therefore, an object of the device of the present invention to provide a new, useful and uncomplicated indexing plunger that does not utilize a retractable pin in the usual sense. It is another object of the device of the present invention is to provide an indexing plunger that is designed to position, locate and hold an object in place. It is yet another object to provide an indexing plunger that is well suited for use in areas with space restrictions or tight clearances. It is still another object of the device of the present invention to provide an indexing plunger assembly that employs a “push and lock” or “push and turn” concept to extend the pin from the retracted position to the extended position and positively hold it, or effectively lock it, in that position. A further object of the present invention is to provide a device that can be constructed of brass, plastic, iron, steel, stainless steel or nearly any other material. It is yet another object of the present invention to provide a device that is simple in design, easy and inexpensive to manufacture, uses relatively few parts and is easy to employ.

It is further an object of the present invention to provide a device that can be of any length or dimensions. It is also an object of the device of the present invention to provide a handgrip that can be of any configuration. It is yet another object of the present invention to provide an invention such that the locking pin can be part of the handgrip or part of the pin assembly. Yet another object of the device of the present invention is to provide a spring-loaded body that can be either threaded or unthreaded. Yet another object of the device of the present invention is to provide a housing that has an additional lock nut for securing the housing into varying positions. Yet another object of the device of the present invention is to provide for a plunger pin with various configurations including tapped, threaded, spherical, pointed, v-shaped, serrated, flat, concave, dog point or slotted.

The device of the present invention has obtained these objects. In one preferred embodiment of the device of the present invention, an indexing plunger is provided whereby a first downward force exerted on a hand grip or a lever will move a pin assembly downwardly and whereby a second rotating force exerted on the hand grip or the lever either clockwise or counterclockwise will lock the device into place by extending the locating pin and thereby locking it into place using the compression force exerted by an internal spring. This embodiment can assume a number of different physical configurations as will become apparent in the detailed description that follows.

In another preferred embodiment of the device of the present invention, the object is to provide an indexing plunger that effectively locks into place when the handgrip is rotated clockwise. The clockwise rotation moves the positioning pin incrementally downwardly through the housing. At all times during the pin's downward movement, a compression spring maintains an opposing force on the handgrip.

The foregoing and other features of the device of the present invention will become further apparent from the detailed description that follows.

### BRIEF DESCRIPTION OF THE DRAWINGS

FIG. 1 is a cross-sectioned front elevational view of one embodiment of the device of the present invention and showing the locating pin in the retracted or “up” position.

FIG. 2 is a cross-sectioned front elevational view of the same embodiment as shown in FIG. 1 and showing the locating pin in the extended or “down” position.

FIG. 3 is an enlarged and exploded cross-sectioned front elevational view of the same embodiment shown in FIGS. 1 and 2.

FIG. 4 is a right side elevational view of the housing of one embodiment of the present invention and showing an L-shaped lock with the lock pin in the “up” or unlocked position.

FIG. 5 is a right side elevational view of the embodiment shown in FIG. 4 with the lock pin in the “down” or locked position.

FIG. 6 is a cross-sectioned front elevational view of another embodiment of the device of the present invention and showing the lever lock and locating pin in the retracted or “up” position.

FIG. 7 is a cross-sectioned front elevational view of the same embodiment as shown in FIG. 6 and showing the lever lock and the locating pin in its extended or “down” position.

FIG. 8 is a right side elevational view of the top of the housing that displays the locking groove.

FIG. 9 is a cross-sectioned front elevational view of yet another embodiment of the device of the present invention and showing the “posi-turn” indexing plunger.

FIG. 10 is an exploded and cross-sectioned front elevational view of the posi-turn indexing plunger shown in FIG. 9.

### DETAILED DESCRIPTION

Referring now to the drawings in detail, wherein like numbered elements correspond to like elements throughout, FIGS. 1 through 5 display one preferred embodiment of the device of the present invention. This embodiment, the “push-lock” indexing plunger, as these inventors like to call it, is generally identified 200. The push-lock indexing plunger 200 is generally comprised of a handgrip 210, a locating pin assembly 220, a housing 230, and a compression spring 240. These elements may be constructed of brass, plastic, iron, steel, stainless steel, or nearly any other material.

The locating pin assembly 220 is a generally cylindrical component having four main features, a main body 221, locating pin 222, a circular aperture 223 through the main body 221, and a threaded top 224. See FIG. 3. Although the top 224 is shown as threaded, it is to be understood that any conventional attachment means, such as a barbed top (not shown) could also be used. The difference between the diameter of the main body 221 and the diameter of the locating pin 222 provides a ledge 225. The purpose of the ledge 225 will become apparent later in this detailed description. The threaded top 224 of the locating pin assembly 220 threads into the bottom 211 of the handgrip 210. If a barbed top were incorporated into the locating pin assembly 220, the top 224 of the locating pin assembly 220 would be pressed into the bottom 211 of the handgrip 210.

Although the handgrip 210 is shown as being generally cylindrical in shape, it is to be understood that the handgrip 210 could be formed in almost any shape that is capable of being gripped by a human hand or manipulated by a tool or other means. The bottom 211 of the handgrip 210 has a circular aperture 212 that is large enough to accommodate the upper portion of the main body 221 of the locating pin assembly 220. At the top of this aperture 212 is another threaded circular aperture 213. The threaded top 224 of the locating pin 220 is functionally adapted to thread into and be received by the threaded aperture 213. Again, if a barbed top were incorporated into the locating pin assembly 220, the aperture 213 would not need to be threaded. The top 214 of the handgrip 210 provides a convenient gripping surface for a person or for a tool of some sort such that the handgrip 210 is easily rotatable.

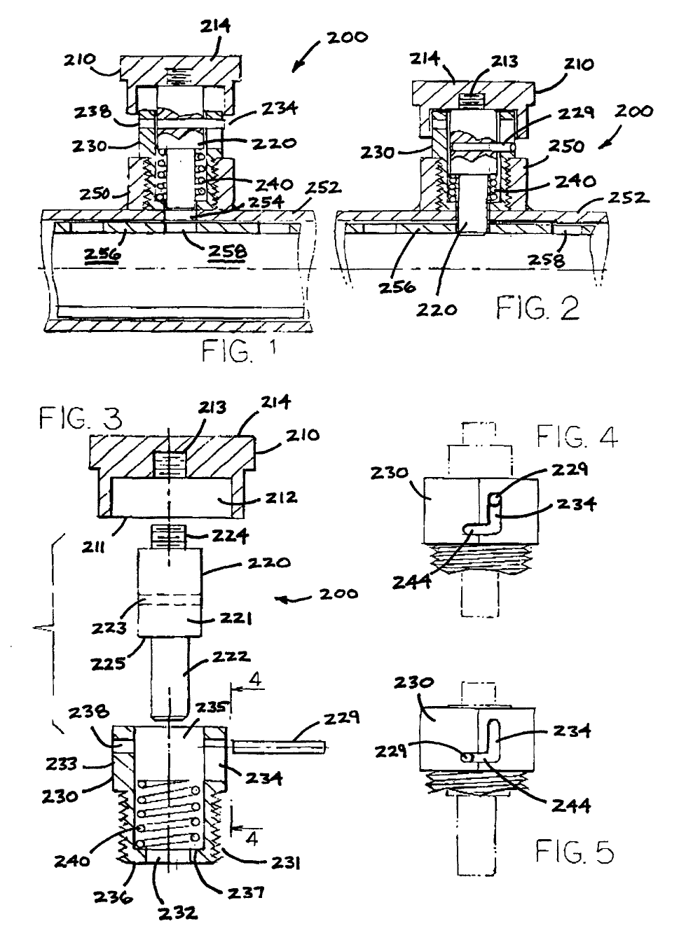

The housing 230 is formed generally in the shape of a hollow cylinder. See FIG. 3. The housing 230 has several features including a lower portion 231, which can be threaded as shown (but need not be threaded), a pin aperture 232 at the base of the lower portion 231, an upper portion 233, an aperture 234 through the upper portion 233 and a hollow interior 235. The upper portion 233 of the housing 230 may also be formed, when viewed from the top, as a square, a hexagon or a circle with flats for securing the housing 230 to a threaded (or unthreaded) base member 250. See FIGS. 1 and 2.

In the application shown, which application is by example only and not in any way to be construed as a limitation of the device of the present invention, the base member 250 is attached generally perpendicularly to an outer tube member 252. The outer tube member 252 includes an aperture 254 that is axially aligned with the pin aperture 232 of the housing 230 when the housing 230 is threadably received within the base 250. An inner tube 256 is provided that is functionally adapted to be received within and be longitudinally movable within the outer tube 252. A plurality of inner tube apertures 258 are defined within the inner tube 256, each being functionally adapted to receive a locating pin 222 therewithin for positioning the inner tube 256 relative to the outer tube 252 as such is desired or required. See FIG. 2. Again, it is to be understood that this application is for illustration purposes only. Any number of similar locating applications could be devised and utilize the device of the present invention. The advantage of the present indexing plunger 200 in this application is that the clearances for releasing the locating pin 222 are not dictated by the distance that the handgrip 210 can be axially displaced. Rather, it is the amount of travel required to disengage the grooved pin 229 from the housing 230.

The interior 235 of the housing 230 is cylindrically shaped and designed to accommodate the pin assembly 220 and the compression spring 240. The interior 235 of the housing 230 narrows abruptly near the base 236 of the housing 230 creating a flange 237. At the center of the base 236 is the pin aperture 232. The pin aperture 232 permits upward and downward movement of the pin 222 therethrough. The pin aperture 232 is preferably large enough to permit passage of the pin 222 but not so large as to prevent precision placement of the pin 222.

Again referring to FIG. 3, a grooved lock pin 229 locks the locating pin 222 into place. In assembly, the push-lock indexing plunger 200 is first positioned. Next, the operator of the plunger 200 depresses the handgrip 210 until the aperture 223 in the main body 221 lines up axially with the apertures 234, 238 in the housing 230. The user then presses the grooved lock pin 229 into the apertures 223, 234, 238 to secure the locating pin 222. It is to be understood that the pin 229 could assume a number of different shapes or forms and that the insertion of the pin 229 into the locating pin 222 could be accomplished by any suitable design or manufacturing expediency.

The flange 237 and the ledge 225 between the main body 221 of the pin 220 and the locating pin 222 operate cooperatively to contain the spring 240 therebetween. The spring 240 provides for tension on the pin assembly 220 such that when the grooved lock pin 229 is removed, the locating pin 222 retracts into the housing 230.

As shown in FIGS. 4 and 5, the grooved lock pin 229 moves downwardly along the L-shaped slot 234 that is defined within the housing 230. This particular embodiment also requires the user to depress the handgrip 214 and then rotate it thereby moving the pin 229 horizontally along the bottom portion 244 of the L-shaped slot 234. The bottom portion 244 of the L-shaped slot 234 could also include an enlarged opening (not shown) such that the pin 229 is effectively “caught” within the slot. Alternatively, the bottom portion 244 could be defined as a slight incline relative to the horizontal for the same purpose. The slot 234 could also be formed in a “J” configuration or in any other configuration that maintains the spring 240 under compression.

FIGS. 6 and 7 illustrate another preferred embodiment of the device of the present invention, termed by these inventors as the “lever-lock” embodiment of the indexing plunger, generally identified 100. This particular embodiment of the device of the present invention is comprised of a unitary indexing lever and pin 110, a compression spring 120, a housing 130 and a retaining ring 140. The indexing lever and pin 110 is a generally L-shaped and rod-like component of the indexing plunger 100. The indexing lever and pin 110 in this particular embodiment has three main features. The lever portion 112 of the indexing lever and pin 110 is formed generally orthogonal to the pin 114 portion of the indexing lever and pin 110. The lever 112 allows for easy lifting and lowering of the pin 114. The lever 112 also provides for easy rotatability of the pin 114 relative to the housing 130. The indexing lever and pin 110 also features a waist 116 on the pin 112. The waist 116 is formed generally orthogonal about the pin and protrudes from the pin 112 in all directions to form a disk, or waist, 116 around a central portion of the pin 112. The purpose of these and other features will become more apparent later in this detailed description.

The housing 130 is generally formed in the shape of a hollow cylinder, as in previous embodiments. The housing 130 has several features including a lower housing portion 131, which can be threaded as shown (but need not be threaded), a pin aperture 132 at the base of the lower portion 131, an upper section 133, a locking groove 134 and a hollow interior 135. The interior 135 of the housing 130 is cylindrically shaped and functionally adapted to accommodate the pin assembly 110 and compression spring 140 therewithin. The interior 135 of the housing 130 narrows abruptly near the base 136 of the housing 130 thereby creating a flange 137. At the center of the base is the pin aperture 132. The pin aperture 132 permits upward and downward movement of the pin 114 relative to the housing 130. The pin aperture 132 is preferably large enough to permit passage of the pin 114 but not so large as to prevent precise placement of the pin 114.

The interior 134 of the housing 130 abruptly narrows so as to provide a flange 137 such that the compression spring 140 is contained at its upper end 141 by the waist 116 of the pin 110 and at its bottom end 142 by the flange 137. In this manner, the compression spring 130 provides some resistance against a downward force and provides upward resistance against the upper portion 133 when the lever 112 is locked into place.

As shown in FIG. 8, the upper portion 133 of the housing 130 features a locking groove 134 defined within the housing 130 for receiving the indexing lever 112. The locking groove 134 can be designed in any number of ways but the basic principle behind the operation of the locking groove 134 is to provide a locking groove 134 to accommodate the lever 112 such that when the lever 112 is pushed down, the pin 114 descends and the lever 112 goes into the locking groove 134. The locking groove 134 provides a further aperture portion, or locking aperture portion, 138 disposed generally perpendicularly either clockwise or counterclockwise from the locking groove 134. The pin 114 is permitted to rotate within the interior 135 of the housing 130 such that the pin 114 can be locked in a downward position by rotating the lever 112 into the locking aperture 138.

In application, the use of the “lever lock” assembly 100 is substantially similar to that of the “push-lock” indexing plunger 200. Instead of pushing and rotating the handgrip 210, however, the indexing lever and pin 110 is used.

Yet another embodiment of the device of the present invention is very similar to the lever lock embodiment of the present invention. This alternative embodiment (not shown) employs a locating pin assembly similar to that of the push-lock indexing plunger assembly with the exception of employing a cam-shaped lobe at the base of the handgrip, which lobe is functionally adapted to slide in to and out of a slot defined within the housing. Another variation (also not shown) would incorporated a recess defined within the lower portion of the locating pin such that one or more spherical ball bearings could be pushed outwardly of the locating pin when the handgrip is depressed. Other variations are also possible, each of which utilizes the push-lock concept of the present invention.

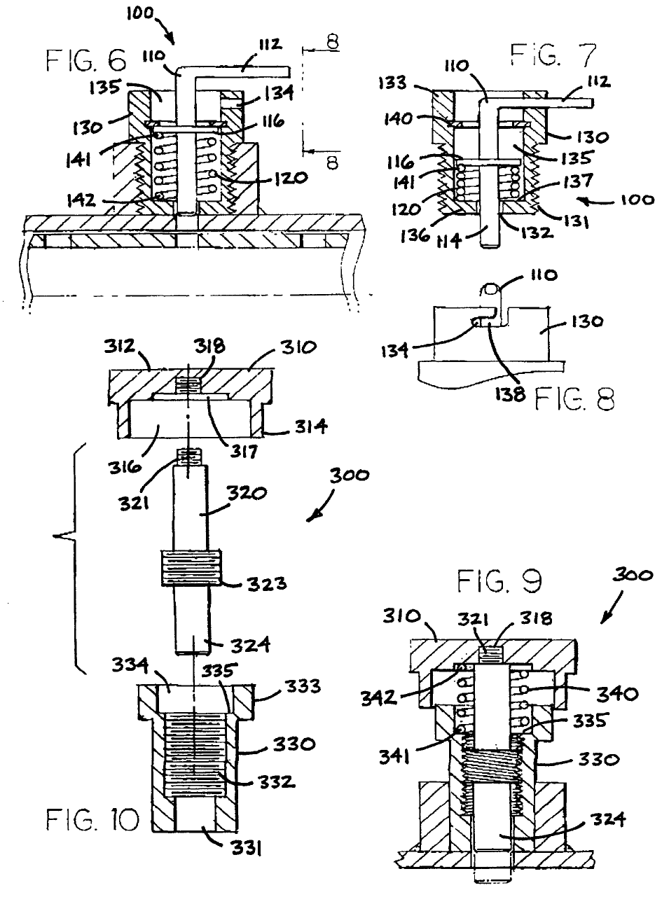

Referring now to FIGS. 9 and 10, the device of the present invention could be embodied in yet another configuration, termed by these inventors as the “posi-turn” positioning plunger, generally indentified 300. The posi-turn plunger 300 provides for a variably positionable indexing plunger. Like the other embodiments, the posi-turn positioning plunger 300 has a handgrip 310, a locating pin assembly 320, a housing 330 and a compression spring 340. The upper portion 312 of the handgrip 310 can be circular, hexagonal or nearly any shape that is capable of being gripped by a human hand or manipulated by a tool or other means. The lower portion 314 of the handgrip 310 provides a generally circular aperture 316 such that the handgrip 310 is in the shape of an inverted cup. In the center of the aperture 316 is a circular depression 317. In the center of the circular depression 317 is a threaded aperture 318.

Unlike the previous embodiments, the posi-turn positioning plunger 300 features an internal mating thread mechanism that provides for an infinitely adjustable plunger pin 324. The internal thread 323 is machined axially on, and as part of, the locating pin assembly 320. The locating pin assembly 320 is generally cylindrically shaped and has a threaded, or barbed, top 321 that is functionally adapted to screw, or be pressed, into and be received by the threaded, or plain hole, aperture 318 of the handgrip 310. The opposite end of the locating pin assembly 320 comprises the locating pin 324 itself.

The housing 330 of this embodiment also generally assumes the shape of a hollow cylinder. The top 333 of the housing 330 features an aperture 334. This aperture 334 continues at uniform depth and then narrows abruptly, thereby creating a flange 335. Below the flange 335, the interior of the housing 330 is threaded 332. The internal threads 323 of the locating pin assembly 320 are functionally adapted to mate with the housing threads 332 located on the inside of the housing 330. Thus, by rotating the handgrip 310, the pin 324 will either ascend to a point where it no longer mates with the housing threads 332 or descend to the user's preference through the aperture 331 in the housing 330.

The posi-turn indexing plunger also employs a compression spring, 340. See FIG. 9. The compression spring 340 has a first bottom end 341 that rests on the flange 335 of the housing 330 and is contained at its second top end 342 by itu the circular depression 317 in the handgrip 310. The properties with respect to the spring in this embodiment of the device, as in other embodiments, such as the stiffness, diameter of the coil, and number of coils can be varied to provide different amounts of resistance.

Another embodiment of the device of the present invention is very similar in operation to the push-lock indexing plunger 200 but utilizes a feature of the posi-turn indexing plunger 300 embodiment of the present invention. This alternative embodiment (not shown) employs engageable threads, not situated between the locating pin and the interior surface of the housing as shown in FIG. 9, but between the exterior surface near the top of the housing 330 and the interior of the handgrip 310. Downward movement of the handgrip 310, followed by rotation of the handgrip 310, will effect a locking of the locating pin 324 into its set position as previously described.

Based upon the foregoing, it will be apparent that there has been provided a new, useful and uncomplicated indexing plunger that does not utilize a retractable pin in the usual sense; that provides an indexing plunger that is designed to position, locate and hold an object in place and that is well suited for use in areas with space restrictions or tight clearances; that employs a “push and lock” or “push and turn” concept to extend the pin from the retracted position to the extended position; that provides a device that can be constructed of brass, plastic, iron, steel or nearly any metal; that is simple in design, easy and inexpensive to manufacture, uses relatively few parts and is easy to employ.

It will also be apparent that the present invention provides a device that can be of any length or dimensions; that provides a handgrip that can be of any configuration; that provides a locking pin that can be formed as part of the handgrip; that provides a spring-loaded body that can be either threaded or unthreaded; that provides a housing that has an additional lock nut for securing the housing into varying positions; that provides for a plunger pin with various configurations including tapped, threaded, spherical, pointed, v-shaped, serrated, flat, concave, dog point or slotted.

The principles of this invention having been fully explained in connection with the foregoing, I hereby claim as my invention:

1. An indexing plunger comprising
a handgrip,
a housing having at least one sidewall and an aperture defined within said at least one sidewall,
a compression spring,
a generally cylindrical locating pin resting on said compression spring within the housing, said locating pin having a top portion that is attachable to said handgrip,
a lock pin,
wherein the spring permits compression such that the lock pin is movable within the housing aperture.

2. The indexing plunger of claim 1 wherein the housing is comprised of a generally hollow cylinder having a top planar surface and a bottom planar surface and further having an aperture defined within top planar surface and an aperture defined within its bottom planar surface.

3. The indexing plunger of claim 2 wherein the exterior of the housing is partially threaded.

4. The indexing plunger of claim 1 wherein the locating pin is comprised of a cylinder of varying diameters including a main body with a slightly larger diameter and a locating pin having a slightly smaller diameter, said main body portion of the locating pin having an aperture defined through it for receiving the lock pin therewithin.

5. The indexing plunger of claim 1 wherein said housing aperture is a slot and the locating pin has an aperture for receiving said lock pin, said lock pin fitting within said slot such that the spring is maintained in compression and the locating pin is locked in position.

6. The indexing plunger of claim 1 wherein said housing aperture is an L-shaped slot having a generally vertical portion and a generally horizontal portion and the locating pin has an aperture for receiving said lock pin, said lock pin fitting within said L-shaped slot such that when the spring permits compression and rotation the lock pin travels down the vertical portion of the L and locks into the horizontal portion of the L thereby extending and locking the locating pin.

7. The indexing plunger of claim 4 wherein the base of the housing narrows abruptly such that a flange is formed, said flange providing a resting place for the compression spring.

8. The indexing plunger of claim 7 wherein the flange defines an aperture that permits precise passage of the locating pin therethrough.

9. The indexing plunger of claim 2 wherein the handgrip is formed in the general shape of a cup and the walls of the cup are large enough to accommodate the housing such that when the locating pin is lowered the handgrip surrounds the top surface of the housing.

10. The indexing plunger of claim 1 wherein said lock pin is in the shape of a cam lobe that is formed as a part of said handgrip and a portion of said cam lobe is engageable with said housing sidewall aperture.

11. The indexing plunger of claim 1 wherein said lock pin is in the shape of a cam lobe that is attachable to said handgrip and a portion of said cam lobe is engageable with said housing sidewall aperture.

12. The indexing plunger of claim 1 including at least one spherical ball bearing and a second sidewall aperture defined within said housing, said bearing being engageable with said housing sidewall second aperture.

13. The indexing plunger of claim 9 wherein said housing has a threaded exterior portion and said handgrip includes a threaded portion that is matingly engageable with the threaded exterior portion of said housing wherein the position of the locating pin is set when the handgrip moved downwardly towards the housing and the handgrip is rotated about the housing.

14. An indexing plunger comprising
a housing having a longitudinally extending cylindrical opening defined within it, said housing having an open top end having a locking groove defined within it and a bottom end having a circular aperture with a flange that surrounds the circular aperture,
a compression spring having a top and a bottom resting on the flange,
a generally cylindrical locating pin having a top portion and a bottom portion, said bottom portion featuring a flat toroidal waist that rests on the top of the spring,
wherein the spring permits compression and rotation such that the top portion of the locating pin fits within the locking groove of said housing.

15. The indexing plunger of claim 14 wherein the top portion of the locating pin is perpendicular to the bottom portion of the locating pin.

16. The indexing plunger of claim 14 wherein the housing has a locking groove such that, when the spring permits compression and rotation, the top portion of the locating pin slides into the groove and permits rotation into a locked position.

17. The indexing plunger of claim 14 wherein the flange defines an aperture that permits precise passage of the locating pin therethrough.

18. An indexing plunger comprising
a housing having a longitudinally extending circular aperture defined within it, said aperture tapering abruptly to form a flange, a threaded interior portion and a bottom end having a circular aperture with a flange surrounding the circular aperture,
a generally cylindrical locating pin having a top portion, a central threaded portion and a bottom portion,
a handgrip attachable to the top portion of the locating pin,
a compression spring with a first end resting on the flange of the housing and a second end abutting the handgrip,
wherein the compression spring provides resistance to moving the locating pin in relation to the housing.

19. The indexing plunger of claim 18 wherein the handgrip is formed in the general shape of a cup and the walls of the cup are large enough to accommodate the housing such that when the locating pin is lowered the handgrip eventually surrounds part of the housing.

20. The indexing plunger of claim 18 wherein the threaded interior portion of said housing and the central threaded portion of said locating pin are matingly engageable.

21. The indexing plunger of claim 18 wherein the locating pin is incrementally movable when the handgrip is rotated about the housing.
